(19) United States
(12) Patent Application Publication
(10) Pub. No.: US 2017/0308310 A1
(43) Pub. Date: Oct. 26, 2017

(54) DYNAMIC ISOLATION CONTEXTS IN VIRTUAL MACHINES WITH DYNAMIC-LINKING

(71) Applicant: Oracle International Corporation, Redwood City, CA (US)

(72) Inventors: Brian Goetz, Williston, VT (US); John Rose, San Jose, CA (US)

(21) Appl. No.: 15/252,635

(22) Filed: Aug. 31, 2016

Related U.S. Application Data
(60) Provisional application No. 62/325,401, filed on Apr. 20, 2016.

(51) Int. Cl. G06F 3/06; G06F 9/455

(52) U.S. Cl. CPC G06F 3/0619; G06F 9/45558; G06F 3/065; G06F 3/067; G06F 2009/45583

(57) ABSTRACT

A method for isolating access to shared software resources is disclosed. As part of deployment of an application, an aspect of an execution context for isolating access to a shared variable may be specified. During execution of the application, a current value of the aspect of the execution context may be determined. An access to the shared variable may be detected during execution of the application, and access to the shared variable may be redirected to an isolated copy of the shared variable dependent upon the current value of the aspect of the execution context and the shared variable.

### PRIORITY CLAIM

The present application claims benefit of priority to provisional application no. 62/325,401 titled “DYNAMIC ISOLATION CONTEXTS IN VIRTUAL MACHINES WITH DYNAMIC-LINKING” and filed on Apr. 20, 2016 which is incorporated by reference in its entirety as though fully and completely set forth herein.

### BACKGROUND

### Technical Field

This disclosure relates to shared software libraries and more particularly to isolating access to class variables.

### Description of the Related Art

Modern computing systems may include multiple processors or processor cores configured to execute software programs or applications. The programs and applications may allow the processors or processor cores to perform a variety of tasks. For example, when executing a web browser program, a processor may perform operations such as requesting data from a server via a network connect, and displaying the request data to a screen or other suitable display device.

Such programs and applications may be written in a high-level programming language, such as, e.g., Java™, C, C++, and the like. In some cases, a high-level programming language will support object-oriented programming. When a program or application is written in object-oriented programming, the program is organized around objects as opposed to actions. In contrast to other programming styles, where logic is defined to manipulate data, object-oriented programming focuses on the manipulation of objects.

An object is a particular instance of a class, which defines a data format and available procedures to objects belonging to the class. Object-oriented programming may also make use of different types of variables. For example, class variables belong to a particular class as a whole and, as such, there is only a single copy of each class variable, whereas instance variables belong to a particular instance of a class, and there is a copy of that variable for each instance of the class. In some programming languages, class variables may be referred to as static variables.

### SUMMARY OF THE EMBODIMENTS

Various embodiments of a method for isolating access to a shared variable are disclosed. Broadly speaking, a method is disclosed in which during deployment of an application, an aspect of an execution context for isolating access to a shared variable included in a library referenced by the application may be specified. During execution of the application, a current value of the aspect of the execution context may be determined. Access to the shared variable may be detected during execution of the application, and access to the shared variable may be redirected to an isolated copy of the shared variable dependent upon the current value of the aspect of the execution context and the shared variable.

In another embodiment, a table includes a plurality of entries, and redirecting the access to the shared variable to the isolated copy includes retrieving a particular entry of a plurality of entries. In a further embodiment, the particular entry includes a location in a memory of the isolated copy of the shared variable.

In a non-limited embodiment, determining the current value of the aspect of the execution context for isolating access to the share resource may include determining a particular execution thread of the plurality of execution threads.

### BRIEF DESCRIPTION OF THE DRAWINGS

FIG. 1 is a functional diagram of an embodiment of isolating access to a shared variable.

FIG. 2 illustrates a functional diagram of an embodiment of redirecting access to an isolated copy of a shared variable.

FIG. 3 illustrates a flow diagram depicting an embodiment of a method deploying an application.

FIG. 4 illustrates a flow diagram depicting an isolating access to a shared variable.

FIG. 5 is a block diagram of one embodiment of a computer system including a shared variable.

While the disclosure is susceptible to various modifications and alternative forms, specific embodiments thereof are shown by way of example in the drawings and will herein be described in detail. It should be understood, however, that the drawings and detailed description thereto are not intended to limit the disclosure to the particular form illustrated, but on the contrary, the intention is to cover all modifications, equivalents and alternatives falling within the spirit and scope of the present disclosure as defined by the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include,” “including,” and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112, paragraph (f) interpretation for that unit/circuit/component. More generally, the recitation of any element is expressly intended not to invoke 35 U.S.C. §112, paragraph (f) interpretation for that element unless the language “means for” or “step for” is specifically recited.

### DETAILED DESCRIPTION OF EMBODIMENTS

To perform a particular task or tasks, a computing system may employ a set of instructions and other encoded information commonly referred to as “software.” Such software may include programs or applications, libraries, as well as other non-executable data. Programs or applications may be written using various programming languages and then compiled into code executable by a processor or processor core included in the computing system.

When writing software, programmers may employ specify storage locations in memory for storing values that may be referenced or changed during execution of a program or application. Such storage locations are commonly referred to as variables and may have an associated identifier or symbolic name. Different variables may have different scopes or visibility within a program or application. For example, some variables may be local to a particular function or subroutine within a program or application, while other variables may be accessible an entire program or application including any associated libraries.

In object-oriented programming languages, variables may have further properties presenting programmers with unique challenges. For example, a variable may be associated with a particular class and not objects of that class. A variable of this type is called “static variable” (also referred to as a “class variable” or “singleton”) and a single copy of the variable may be shared by all instances of the class to which the static variable belongs. The programming language, in conjunction with hardware platforms and operating systems, ensure that only one copy of the static variable exists. This may present difficulties when such a static variable is included in shared library or multiple versions of an application are executed on a common hardware platform as the different versions of the application each attempt to overwrite or change the static variable.

In some programming languages, a class may include both per-instance state and per-class state. For example, as depicted in Program Code Example 1, the Java programming language converts a variable to a per-class state with the addition of the static keyword.

Program Code Example 1:

```
  class C {
    static String perClassVariable;
    String perInstanceVariable;
}
```

Alternatively, as shown in Program Code Example 2, the Scalable Language (Scala), allows a programmer to declare objects or classes, where an object is implicitly a singleton.

Program Code Example 2:

```
Class C {
    perInstanceVariable: String;
}
object CStatics {
  perClassVariable: String;
}
```

In both Program Code Example 1 and Program Code Example 2, the programming language and a virtual machine on which an application is being executed ensure that there is only one copy of the per-class variable.

Since only one copy of a class variable exists, it is difficult to isolate different accesses to the class variable. For example, if the class variable exists within a software library shared by two different applications, each application may attempt to access the variable, which may result in corruption of data stored in the class variable, or exposure of sensitive data that should not be shared outside the application. To prevent such corruption accesses to the class variable need to be isolated from each other. In order to isolate the class variable, multiple copies of the shared software library may be loaded. Loading multiple copies of a shared library may duplicate the effort of system to load the separate copies, as well as increase memory utilization.

Moreover, a language-level method of isolating different accesses to a class variable may be insufficient. When a software library is written, a complete understanding of the various contexts in which the library may be used may not be available. Such context may only be available when the application is deployed and access to the deployment configuration may not be a static property of the code.

The embodiments illustrated in the drawings and described below may provide techniques for specifying an isolation context for class variables while eliminating the need for loading multiple copies of the shared library or having isolation context knowledge prior to the deployment.

When an application is executed, there are many different factors affecting the execution, collectively forming an execution context for the application. As used and described herein, an execution context is any suitable combination of hardware parameters, software parameters, or user input parameters that affects execution of a program or application for which values may be determined during runtime. For example, an execution context may included factors (also referred to as “aspects” of the execution context) such as the type of hardware, the version of the operating system, a particular user, and any parameter, setting, configuration, or other stored data for which the value can be determined during runtime based on the operating environment, executing sub-processors, and stored data leading up to an access of a static state. Each aspect may have multiple possible values, which may change during runtime with each access to the static state. For example, a particular aspect may include the day of the week, or a current user that initiate the current request.

Each value of a particular aspect may correspond to a distinct computational activity. Since there is only a single copy of the static variable, an access corresponding to one value of an aspect may corrupt data in the static variable previously stored in a different access belonging to a different activity. To prevent such corruption, the individual accesses must be isolated from each other. As used and described herein, isolating accesses refers to a method in which each access is redirected to a corresponding copy of the static variable or, one or more accesses are directed the static variable and one or more others accesses are redirected to a copy. In order to isolate accesses to a static variable included in shared software libraries, an aspect of the execution context for a particular static variable may be specified when a particular application that uses the shared library is deployed on a computing system. As described below in more detail, different accesses to the static variable corresponding to different values of the aspect may then be isolated. The aspect of the execution context may be specified as metadata that may be read by a computer processor, or virtual machine (VM) during execution of the deployed application.

In the execution context of an application, a particular aspect of the execution context for isolating a static variable may be specified. For example, the aspect may be specified as per-application. That is, accesses to the static variable from different applications must be isolated. It is noted that the aspect of the execution context for isolating a given static variable may be per-thread, per-tenant, per-classloader, per-cluster when using a distributed grid facility, or any other suitable context.

A particular example of the need for isolating access to shared variables is depicted in Program Code Example 3. Hypertext Markup Language (HTML) documents may, through the use of tags such as A (indicating a link) or IMG (indicating an image) reference other documents or resources. In some cases the, the referenced document has a fully qualified address, such as http : //my.co.com/path/to/document.html. Alternatively, a relative address such as path/to/document.html may be employed. In some cases, a system-specified such as /absolute/path/to/document.html may be used.

As indicated in Program Code Example 3, a library for use in the above-described situation may provide a static method to set a default file system path to look for system-specific resource paths.

Program Code Example 3:

```
class HTMLParser {
  private static Path defaultResourcePath;
  public static void setResourcePath(Path p) {
    defaultResourcePath = p;
    }
}
```

If multiple tenants rely on this library, then calls to setResourcePath ( ) by one tenant should not affect other tenants. To ensure that the multiple calls do not affect each other, the aspect of the context environment for Html Parser may specify the isolation context as per-tenant, which may be specified through a configuration file like the XML, file depicted in Configuration Example 1. As such, each tenant would access an isolated copy of the static variables included in this shared variable.

Configuration Example 1:

<isolation-configuration>
<class name = ″HtmlParser″ isolation-domain=″tenant″ />
</isolation-configuration>

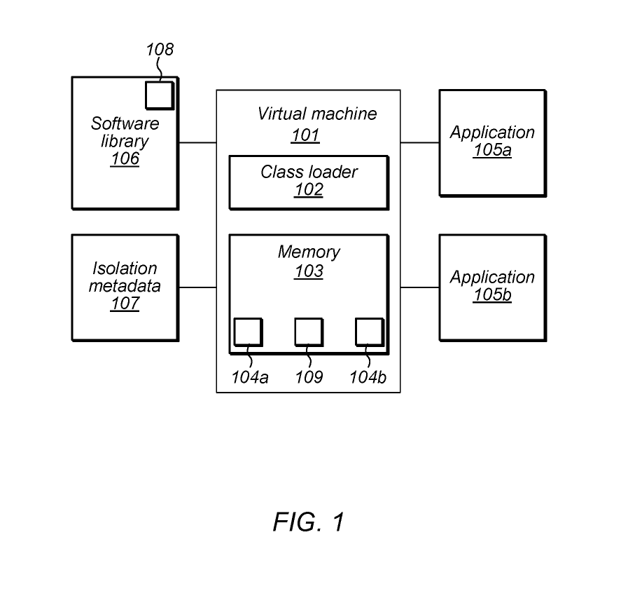

Turning to FIG. 1, a functional diagram depicting isolating access to a static variable is illustrated. In the illustrated embodiment, Virtual machine 101 may receive Applications 105a and 105b for execution. Applications 105a and 105b may be written in any suitable programming language that supports object-oriented programming. Each of Applications 105a and 105b may reference Software library 106, which includes static variable 108. It is noted that although the embodiment illustrated in FIG. 1 depicts a single static variable, in other embodiments, an aspect of the execution context may be specified for isolating accesses for all static variables in a particular class, a particular package, a particular module, or any suitable portion of application code. As used and described herein, one or more static variables for which an aspect of the execution for isolating accesses is specified are referred to as a “shared resource.”

Isolation metadata 107 may include an aspect of the execution context for isolating access to static variable 108. For example, as described above, if multiple tenants rely on static variable 108, then Isolation metadata 107 may indicate that static variable 108 is to be isolated on a per-tenant basis. Alternatively, if both Application 105a and Application 105b rely on static variable 108, then Isolation metadata 107 may specify that static variable 108 is to be isolated on a per-application basis.

Virtual machine 101 is a particular embodiment of an abstract computing machine that enables a computer system to run applications written with particular programming languages such as, Java, for example. In various embodiments, Virtual machine 101 may support dynamic linking between Applications 105a and 105b, and references to portions of Shared library 106 at runtime. As used and described herein dynamic linking is a process in which shared libraries are loaded into a running process and bound to the running process. For example, when Application 105a is executed, Virtual machine 101 loads Shared Library 106 into Memory 103 and links Shared Library 106 to Application 105a.

Virtual machine 101 includes Class loader 102 and Memory 103. Class loader 102 may be dynamically load classes into Virtual Machine 101. In some embodiments, classes are loaded only on demand. Although depicted as a single entity, Class loader 102 may include multiple different loaders, each responsible for loading classes included in different libraries.

Memory 103 may provide storage for portions of Applications 105a and 105b during execution. Additionally, memory 103 may store isolated copies of static variable 108 that are isolated on the basis of the aspect of the execution context included in Isolation metadata 107. For example, if the aspect of the execution context specified in Insolation metadata 107 indicate isolation on a per-tenant basis, then when a particular tenant accesses static variable 108 through one of Applications 105a or 105b, the access may be redirected to isolated copy 104a. Accesses by another tenant may be redirected to isolated copy 104b.

In addition to storing the isolated copies of static variable 108, Memory 103 may additionally store table 109. Table 109 may, in various embodiments, include multiple entries. Each entry may correspond to a particular value for a given aspect of the isolation context. As described below in more detail, when an access to static variable 108 is detected, Virtual machine 101 may retrieve data indicative of a storage location of an isolated copy of static variable 108 (e.g., isolated copy 104a) from table 109 using a current value of the aspect of the execution context associated with static variable 108. In some embodiments, a particular entry in table 109 may include the isolated copy of the shared variable.

A current value of a particular aspect of the execution context may be determined by Virtual machine 101 at the start of execution of an applications, such as, Application 105a, for example. Each aspect of the execution context may have multiple possible values. For example, when an aspect of the execution context specifies isolation for a static variable on a per-thread basis, then a current value of the aspect of the execution context may be a particular execution thread. In a similar fashion, particular applications, tenants, processors, users, or any suitable combination thereof, may be a current value for an aspect of the execution context.

It is noted that the embodiment depicted in FIG. 1 is merely an example. In other embodiments, Virtual machine 101 may be replaced by a processor or processor core and preprocessed versions of Applications 105a and 105b and Software library 106.

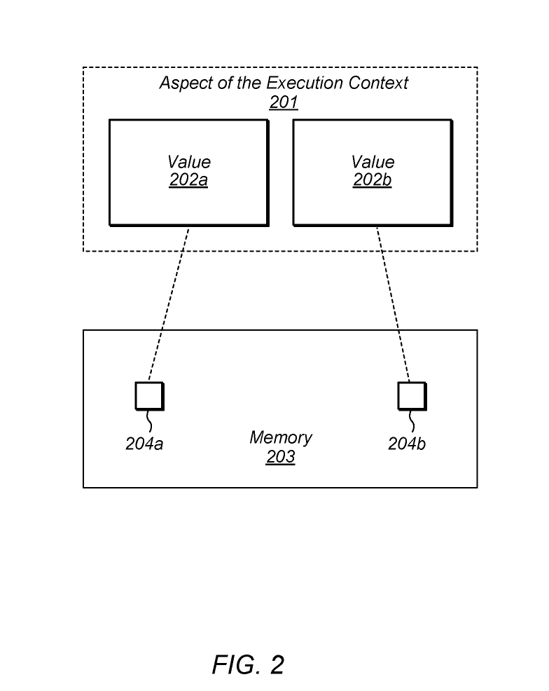

A functional diagram depicting redirecting access to a static variable is illustrated in FIG. 2. In the illustrated embodiment, Aspect of the Execution Context 201 includes two possible values, Value 202a and Value 202b. It is noted that Aspect of the Execution Context 201 may, in various embodiments, be included in metadata defined during deployment of an application, such as, Isolation metadata 107 as illustrated in FIG. 1, for example.

A current value for Aspect of the Execution Context 201 may be determined during execution of an application, such as, Application 105a, for example. In some embodiments, a virtual machine, such as, e.g., Virtual machine 101, may execute one or more functions to determine the current value, which may correspond to one of Values 202a and 202b.

Each possible value for Aspect of the Execution Context 201 may correspond to an isolated copy of a static variable. In the present embodiment, Memory 203 includes isolated copies 204a and 204b. In various embodiments, isolated copies 204a and 204b may correspond to isolated copies 104a and 104b as depicted in the embodiment illustrated in FIG. 1. Each possible value for Aspect of the Execution Context 201 is mapped to a different isolated copy of the static variable. For example, Value 202a is mapped to isolated copy 204a, and Value 202b is mapped isolated copy 204b. In various embodiments, the mapping from possible values of Aspect of the Execution Context 201 to corresponding isolated copies of the shared variable may be stored in a table as described above in regard to FIG. 1.

When an access to the static variable is detected, the execution platform for the application, determines the current value for Aspect of the Execution Context 201. Based on the current value of Aspect of the Execution Context 201, the access is redirected to one of Values 204a and 204b. At a later time, a different access may result in the access being redirected to a different one of Values 204a and 204b due to a different current value of Aspect of the Execution Context 201. For example, if Aspect of the Execution Context 201 specifies a per-tenant isolation context, a first access may be from a first tenant using the application and a second access may be from a second tenant using the application. Since each access is redirected on the basis of the current tenant, tenants can only access their respective copies of the static variable. Such isolation of static variables may, in some embodiments, improve security of a computing system.

Although only two values for the Aspect of the Execution Context 201 are depicted in the embodiment illustrated in FIG. 2, in other embodiments, other values for the Aspect of the Execution Context 201 are possible and contemplated.

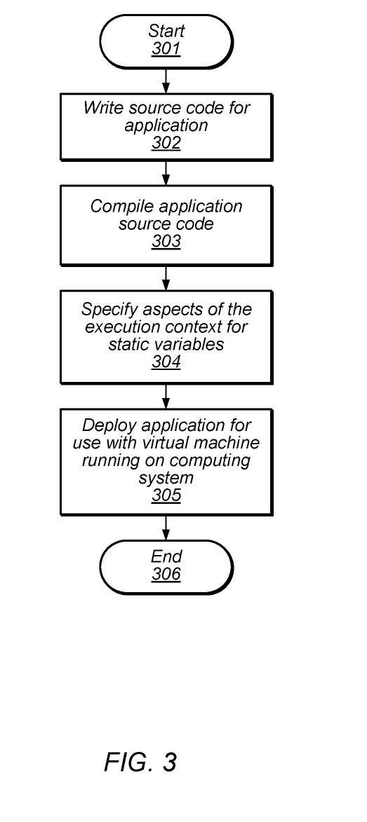

Turning to FIG. 3, a flow diagram depicting an embodiment of a method for deploying an application is illustrated. The method begins in block 301. Source code for the application may then be written (block 302). In various embodiments, the source code may be written in a programming language that supports objected-oriented programming, such as, Java, for example. The source code for the application may include a reference to one or more software libraries, such as, software library 106 as illustrated in FIG. 1, for example. Such libraries may include classes and objects that are used in the source code for the application, and may be linked to the application at runtime.

Once the source code for the application has been written, the source code may be compiled into executable code (block 303). It is noted that, in some embodiments, libraries referenced by the application may be statically linked at the time of compilation while, in other embodiments, such libraries may be dynamically linked during runtime.

Once the source code has been compiled, aspects of the execution context may be specified for static variables included in the application (block 304). In some embodiments, the aspects of the execution context may be specified in metadata stored in a computing system, such as, Isolation metadata 107 as illustrated in the embodiment of FIG. 1. Different aspects of the execution context may be specified for different static variables or collections of static variables.

The application may then be deployed for use on a virtual machine (block 305). In various embodiments, the application may be deployed for execution by a virtual machine, such as, e.g., Virtual machine 101, as depicted in the embodiment illustrated in FIG. 1. Alternatively, the application may be deployed for use on any suitable processor or processor core. In such cases, preprocessing of the application code may be employed to allow for redirecting of accesses to static variables. Once the application has been deployed, the method may conclude in block 306.

As described above, for a given aspect of the execution context specified for a static variable, the execution platform for an application, such as, e.g., Virtual machine 101, may determine a current value for the aspect of the execution context to be used when an access to the static variable is detected. A code example of a particular embodiment of compile-time method for isolating access to a static variable is illustrated in Program Code Example 4.

In Program Code Example 4, an int variable of a class C is marked for isolation on a per-thread basis. This is accomplished by selecting the type java.lang.ThreadLocal. Such a selection may be based on isolation metadata, such as, e.g., Isolation metadata 107 as illustrated in FIG. 1. A current value of the aspect of the execution context, may be determined by executing Thread.currentThread ( ). Using the current thread value, the appropriate isolation copy of the static varaible may be determined by ThreadLocal.get ( ). In various embodiment, ThreadLocal.get ( ) may access a table which includes a plurality of entries mapping particular thread values to corresponding isolated copies of the static variable. It is noted that the code depicted in Program Code Example 4 a particular compile-time solution for isolating access to shared variables. As described below in more detail, isolating access to static variables may be based on metadata, such as, e.g., Isolation metadata 107 of FIG. 1, provided at runtime.

Program Code Example 4:

```
class C {
  private static int intVal = 42;
  static int getIntVal ( ) {
        return intVal;
  }
  static int bumpIntVal ( ) {
        return ++intVal;
  }
  // test harness:
  public static void main(String . . . args) throws Exception {
      assert(getIntVa l( ) == 42);
      bumpIntVal ( );
      assert(getIntVal ( ) == 43);
      Thread t2 = new Thread (″t2″) {
        @Override public void run ( ) {
          assert(getIntVal ( ) == 42);
          bumpIntVal ( );
          assert(getIntVal ( ) == 43);
          bumpIntVal ( );
          assert(getIntVal ( ) == 44);
        }
      };
      t2.start ( );
      t2.join ( );
      assert(getIntVal ( ) == 43);
  }
}
<isolation-configuration>
    <class name=″C″isolation-domain=″thread″ />
</isolation-configuration>
```

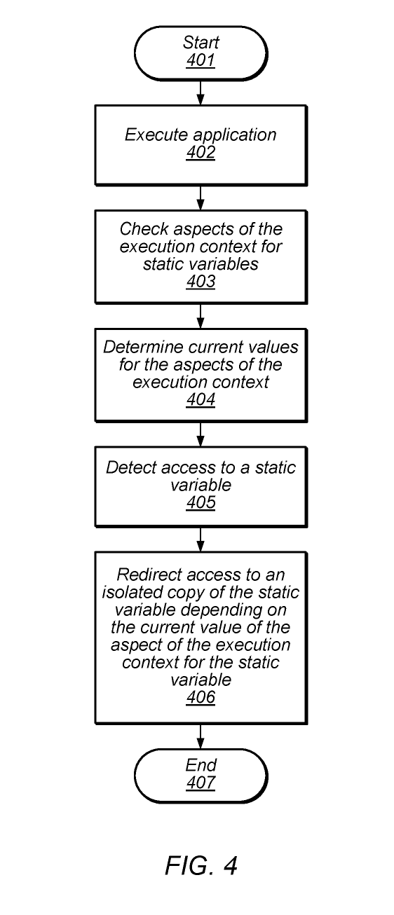

A flow diagram depicting an embodiment of a method for isolating the context of a static variable is illustrated in FIG. 4. The method begins in block 401. An application, such as, e.g., application 105a may then be executed (block 402). In various embodiments, the application may be executed by a virtual machine, such as, virtual machine 101 as illustrated in FIG. 1. In such cases, a class loader, such as, e.g., class loader 102, may load classes included in the application into memory allocated for the virtual machine. It is noted that, in some embodiments, the application may be executed without the benefit of a virtual machine and that processing of the application may be performed gather information related to shared variables that may be accessed by the application.

During execution, the virtual machine may then check the aspects of the execution context of static variables used by the application (block 403). In various embodiments, the aspects of the execution context may be specified in metadata, such as, e.g., isolation metadata 107 as illustrated in the embodiment of FIG. 1. In some embodiments, virtual machine may setup a table in memory, such as, e.g., table 109 as depicted in the embodiment of FIG. 1. The table may include multiple entries for a given static variable and its specified aspect of the execution context. Each entry may correspond to a particular value of the aspect of the execution context for the static variable.

Once the aspects of the execution context have been examined, the virtual machine may then determine current values for the aspects of the execution context (block 404). In some embodiments, the virtual machine may execute a function to gather information for a given aspect of the execution context. For example, in the case of a per-thread isolation aspect, the virtual machine may execute a get_thread ( ) function, which returns identification information for a particular execution thread in which the application is being executed. In other embodiments, different functions, or other suitable means, may be employed to determine current values for the aspects of the execution context. It is noted that, in some embodiments, the current values may be determined each time an access to a static variable is detected, as the values may have changed since a previous access.

The virtual machine may then detect access to a particular static variable (block 405). The access may be the result of the application, or another application also being executed by the virtual machine. Alternatively, the access to the static variable may be the result of a different client or user accessing the application via a network connection or other suitable means.

Using the current value for the aspect of the execution context for the particular static variable, the virtual machine may then redirect the access to an isolated copy of the static variable depending upon the current value of the aspect of the execution context as well as the original static variable (block 406). In various embodiments, the virtual machine may maintain multiple copies of the particular static variable. Each copy of the static variable may correspond to a particular value for the aspect of the execution context specified for the particular static variable. By maintaining multiple copies, access to the particular static variable may be restricted to particular applications, threads, tenants, and the like.

In some embodiments, the virtual machine may access the aforementioned table to select which of the multiple copies of the static variable is to be accessed. The table may be accessed using the current value of the aspect of the execution context as an index into the table to retrieve a particular entry. The entry may, in various embodiments, include a location of a particular copy of the static variable or, alternatively, include an actual copy of the static variable.

Once the static variable access has been performed using the copy of the static variable, the method concludes in block 407. It is noted that the embodiment of the method depicted in FIG. 4 is merely an example. In other embodiments, different operations and different orders or operations may be employed.

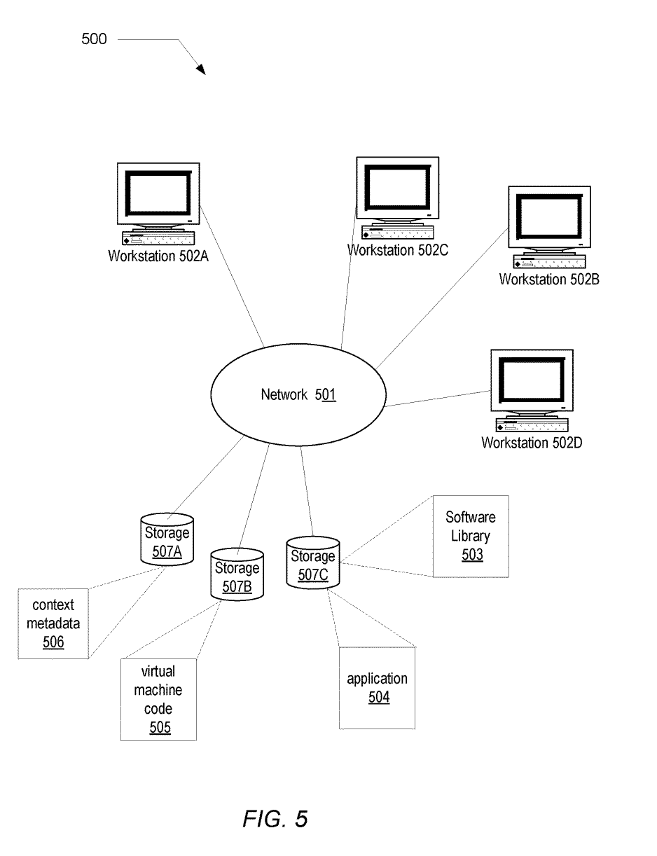

Turning to FIG. 5, a block diagram of one embodiment of a computer system including an integrated circuit design tool. The computer system 500 includes a plurality of workstations designated 502A through 502D. The workstations are coupled together through a network 501 and to a plurality of storage devices designated 507A through 507C. In one embodiment, each of workstations 502A-502D may be representative of any standalone computing platform that may include, for example, one or more processors, local system memory including any type of random access memory (RAM) device, monitor, input output (I/O) means such as a network connection, mouse, keyboard, monitor, and the like (many of which are not shown for simplicity).

In one embodiment, storage devices 507A-507C may be representative of any type of mass storage device such as hard disk systems, optical media drives, tape drives, ram disk storage, and the like. As such, program instructions for different applications may be stored within any of storage devices 507A-507C and loaded into the local system memory of any of the workstations during execution. As an example, as shown in FIG. 5, context metadata 506 is shown stored within storage device 507A, while virtual machine code 505 is stored within storage device 507B. Further, application 504 and software library 503 is stored within storage device 507C.

In one embodiment, portions of software library 503 may be dynamically-linked to application 504 by a virtual machine generated by executing virtual machine code 505 on a given one of workstations 502A-D. As described above, during deployment of application 504 on computer system 500, aspects of the execution context for isolating access to static variables in software library 503 may be specified in context metadata 506. As described above, during execution of the application 504, when a particular static variable of software library is accessed, the virtual machine determine a current value of the aspect of the execution context specified for the particular static variable, and then redirect access to a copy of the particular static variable corresponding to current value of the aspect of the execution context. It is noted that aspect of the execution context specified in context metadata 506 may be on a per-application, per-thread, per-tenant, or any other suitable aspect of the execution context.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
specifying, during deployment of an application, an aspect of an execution context for isolating access to a shared variable included in a library referenced by the application;
during execution of the application, determining a current value of the aspect of the execution context;
detecting an access to the shared variable during execution of the application; and
in response to detecting the access, redirecting the access to the shared variable to an isolated copy of the shared variable dependent upon the current value of the aspect of the execution context and the shared variable.

2. The method of claim 1, wherein redirecting the access to the shared variable to the isolated copy includes retrieving a particular entry of a plurality of entries stored in a table.

3. The method of claim 2, wherein the particular entry includes a location in memory for the isolated copy for the shared variable.

4. The method of claim 1, wherein determining the current value of the aspect of the execution context for isolating access to the shared variable includes determining a particular execution thread of a plurality of execution threads.

5. The method of claim 1, wherein determining the current value for the aspect of the execution context for isolating access to the shared variable includes determining an application context from a plurality of application contexts provision on a virtual machine.

6. The method of claim 1, wherein the shared variable includes at least one static variable.

7. A non-transitory computer-accessible storage medium having program instructions stored therein that, in response to execution by a computer system, causes the computer system to perform operations including:
specifying, during deployment of an application, an aspect of an execution context for isolating access to a shared variable included in a library referenced by the application;
during execution of the application, determining a current value for the aspect of the execution context;
detecting an access to the shared variable during execution of the application; and
in response to detecting the access, redirecting the access to the shared variable to an isolated copy of the shared variable dependent upon the current value for the aspect of the execution context and the shared variable.

8. The non-transitory computer-accessible storage medium of claim 7, wherein redirecting the access to the shared variable to the isolated copy includes retrieving a particular entry of a plurality of entries stored in a table.

9. The non-transitory computer-accessible storage medium of claim 8, wherein the particular entry includes a location in memory for the isolated copy for the shared variable.

10. The non-transitory computer-accessible storage medium of claim 7, wherein determining the current value for the aspect of the execution context for isolating access to the shared variable includes determining a particular execution thread of a plurality of execution threads.

11. The non-transitory computer-accessible storage medium of claim 7, wherein determining the current value for the aspect of the execution context for isolating access to the shared variable includes determining an application context from a plurality of application contexts provision on a virtual machine.

12. The non-transitory computer-accessible storage medium of claim 7, wherein determining the current value for the aspect of the execution context for isolating access to the shared variable includes determining a particular processor of a plurality of processors.

13. The non-transitory computer-accessible storage medium of claim 7, wherein the shared variable includes at least one static variable.

14. A system comprising:
one or more memories configured to store instructions, and
one or more processors configured to receive instructions from the one or more memories and execute the instructions to cause the system to perform operations comprising:
specifying, during deployment of an application, an aspect of an execution context for isolating access to a shared variable included in a library referenced by the application;
during execution of the application, determining a current value for the aspect of the execution context for the shared variable;
detecting an access to the shared variable during execution of the application; and
in response to detecting the access, redirecting the access to the shared variable to an isolated copy of the shared variable dependent upon the current value for the aspect of the execution context and the shared variable.

15. The system of claim 14, wherein redirecting the access to the shared variable to the isolated copy includes retrieving a particular entry of a plurality of entries stored in a table.

16. The system of claim 15, wherein the particular entry includes a location in memory for the isolated copy for the shared variable.

17. The system of claim 15, wherein the particular entry includes the isolated copy of the shared variable.

18. The system of claim 14, wherein determining the current value for the aspect of the execution context for isolating access to the shared variable includes determining a particular execution thread of a plurality of execution threads.

19. The system of claim 14, wherein determining the current value for the aspect of the execution context for isolating access to the shared variable includes determining an application context from a plurality of application contexts provision on a virtual machine.

20. The system of claim 14, wherein the shared variable includes at least one static variable.
